(19) United States
(12) Patent Application Publication
(10) Pub. No.: US 2024/0151990 A1
(43) Pub. Date: May 9, 2024

(54) Electro-Optical Component

(71) Applicants: IMEC VZW, Leuven (BE); Universiteit Gent, Gent (BE)

(72) Inventors: Rik Verplancke, De Pinte (BE); Herbert De Smet, Destelbergen (BE)

(21) Appl. No.: 18/549,114

(22) PCT Filed: Mar. 8, 2022
(86) PCT No.: PCT/EP2022/055880

§ 371 Date: Sep. 5, 2023

(30) Foreign Application Priority Data
Mar. 11, 2021 (EP) 21162105.7

(51) Int. Cl. G02C 7/08; G02C 7/04; G02F 1/1339

(52) U.S. Cl. CPC G02C 7/083; G02C 7/041; G02F 1/13396; G02C 2202/20

(57) ABSTRACT

Example embodiments relate to an electro-optical component. One embodiment includes an electro-optical component for adaptive visual correction. The component includes a first transparent substrate. The component also includes a second transparent substrate. Additionally, the component includes an optical structure disposed on the first transparent substrate. Further, the component includes a liquid-crystal gap located between the optical structure and the second transparent substrate. Even further, the component includes a first transparent electrode and a second transparent electrode located on opposite sides of the liquid-crystal gap. Still further, the component includes a plurality of spacers located in the liquid-crystal gap between the second transparent substrate and the optical structure. The plurality of spacers includes at least one spacer having a different height than another spacer of the plurality of spacers.

### TECHNICAL FIELD

The present inventive concept relates to an electro-optical component for adaptive visual correction, to a contact lens comprising the same, and to methods for manufacturing the same.

### BACKGROUND

Presbyopia is an age-related disorder which affects the accommodation capability of the eyes. One possible treatment of presbyopia lies in the use of smart contact lenses which comprise electro-optical components for adaptive visual correction. Such an electro-optical component typically comprises liquid crystals. Such a component comprising liquid crystals may comprise two substrates separated by a small gap. Through activation of the liquid crystals in the gap, the visual correction of the electro-optical component may be adapted, helping with accommodation.

It is a challenge to prevent substrate sagging, which could adversely affect the optical properties of the electro-optical component. Conventionally, so-called ‘spacers’ of equal length are used in the liquid-crystal gap, typically being located at ridges of the optical structure.

### SUMMARY

An objective of the present inventive concept is to provide an electro-optical component for adaptive visual correction providing better control of the liquid-crystal gap distance.

According to an aspect of the present inventive concept there is provided an electro-optical component for adaptive visual correction, comprising a first transparent substrate; a second transparent substrate; an optical structure disposed on said first transparent substrate; a liquid-crystal gap located between said optical structure and said second transparent substrate; a first transparent electrode and a second transparent electrode, located on opposite sides of said liquid-crystal gap; and a plurality of spacers located in said liquid-crystal gap between said second transparent substrate and said optical structure, wherein said plurality of spacers comprises at least one spacer having a different height than another spacer of said plurality of spacers.

As a liquid-crystal cap should be understood a gap filled with liquid crystals, or a gap to be filled with liquid crystals.

As a consequence of the liquid-crystal gap being located between the optical structure and the second transparent substrate, the optical structure is in contact with, and/or is configured to be in contact with, the liquid crystals of the liquid-crystal gap. As a further consequence, the optical structure is located adjacent to the liquid-crystal gap.

The plurality of spacers comprising at least one spacer having a different height than another spacer, i.e., there being spacers of different height, allows for a freer placement of spacers throughout the liquid-crystal gap. For example, instead of just having the option of placing constant height spacers at apices of the optical structure, such as ridges, bulges, or the like, as conventionally done, spacer placement may be optimized to prevent sagging of the second transparent substrate or of the first transparent substrate, in particular when the substrates are not rigid, for example because they are very thin and/or made of flexible material. Further or additionally, this may be particularly useful for constant-height Fresnel-lenses, where sagging otherwise may become a problem due to the relatively large distances between apices near the center of the lens. At a given location where a spacer is to be placed to prevent sagging, the spacer height may be chosen to that the spacer is just long enough to keep the desired distance and resulting gap between both substrates. This may result in a better control over the cell gap, which is particularly beneficial if using very thin (e.g. 50 μm thickness) and/or flexible substrates. Therefore, it may be possible to use thinner and/or more flexible substrates than otherwise possible, allowing, for example, for a thinner and/or lighter contact lens.

According to an embodiment, said electro-optical component has a curved shape. As a curved shape should be understood the layers of the electro-optical, instead of forming parallel planes, each having a convex shape, while still being locally parallel or essentially locally parallel. For example, the curved shape may be a spherically curved shape.

Electro-optical components with curved geometries are particularly useful for integrating into a scleral contact lens, allowing the thickness of the latter to be reduced, due to better following of the curved shape of the eye. Electro-optical components with curved geometries are a particularly beneficial application of the present inventive concept, due to the particular challenge of preventing sagging in a curved geometry.

According to an embodiment, said optical structure comprises a central bulge or indent and a plurality of ridges located radially outside said central bulge or indent, wherein said plurality of spacers comprises a plurality of different-height spacers located at said central bulge or indent; and a plurality of constant-height spacers, one spacer of said plurality of constant-height spacers being located at each of said ridges.

The central bulge or ident is typical of, e.g., Fresnel lens structures.

A spacer being located “at” a ridge should be understood as the spacer terminating anywhere on the ridge, for example, but not necessarily, at the apex of the ridge.

Through the plurality of different-height spacers located at the central bulge or indent, sagging in such a, typically larger, region may be prevented, while easier-to-manufacture constant-height spacers may be used at the ridges, which typically are closer spaced and therefore less prone to sagging.

According to an embodiment, said optical structure comprises a central bulge or indent and a plurality of ridges located radially outside said central bulge or indent, wherein said plurality of spacers comprises a plurality of different-height spacers located at said central bulge or indent; and a second plurality of spacers, each spacer of said second plurality of spacers being located at a respective ridge of said plurality of ridges, wherein each of the spacers of said second plurality of spacers is located at a same radial distance from a respective apex of the respective ridge.

Through the plurality of different-height spacers being located at the central bulge or indent, sagging in such a typically larger region may be prevented, Meanwhile, placing the spacers of the second plurality of spacers at a same radial distance from the respective ridge apex allows easier placement of the spacers of the second plurality of spacers, thus allowing for a less complicated design.

According to an embodiment, a spacer of said plurality of spacers has a rounded cross section. For example, the rounded cross section may be circular. This minimizes the contact area with the liquid crystal, less disturbing the alignment of the liquid-crystal molecules, allowing for a better-functioning electro-optical component.

According to an embodiment, said optical structure is a Fresnel lens structure. Such a structure typically has a structure comprising bulges, indents, and/or ridges, wherein application of the present inventive concept is particularly beneficial.

According to another aspect, there is provided a contact lens comprising the electro-optical component of the present disclosure. The contact lens may, for example, be a scleral contact lens.

In addition, this aspect may generally present the same or corresponding advantages as the former aspect.

According to another aspect, there is provided a method of manufacturing the electro-optical component for adaptive visual correction according to the above, said method comprising applying a plurality of successive photolithographic layers to a substrate, wherein said at least one spacer is produced from at least one of said plurality of layers.

In addition, this aspect may generally present the same or corresponding advantages as the former aspects.

According to an embodiment, each layer is a photo-imageable spin-on layer, such as an SU-8 layer. This is a particularly advantageous method of producing the layers.

According to an embodiment, said substrate is said second transparent substrate. This has an advantage of reducing the number of manufacturing steps, allowing for easier manufacturing, especially in small volumes.

According to an embodiment, said substrate is a master mold and said method further comprises molding at least part of said second transparent substrate based on said master mold. The molding of the at least part of the second transparent substrate based on the master mold may be direct, or indirect through one or more intermediate molds.

Producing a master mold based on which at least part of the second transparent substrate is molded allows, for example, for the creation of several master molds, allowing for easy scaling up of manufacturing.

According to an embodiment, said master mold is a positive master mold. As a positive mold should be understood a mold the features of which directly corresponding to the features of the final spacers, i.e., a convex feature of the mold corresponding to a convex feature of the spacer. Using a positive master mold may have an advantage of making the master mold easier to produce.

According to an embodiment, said master mold is a negative master mold. As a negative mold should be understood a mold the features of which being inverted compared to the features of the final spacers, i.e., a convex feature of the mold corresponding to a concave feature of the spacer.

According to another aspect, there is provided a method of manufacturing the electro-optical component for adaptive visual correction according to the above, comprising producing a substrate comprising a plurality of spacers; and creating said second transparent substrate by removing material from at least one spacer on said substrate.

This allows for a large, almost continuous range of spacer heights, increasing flexibility.

In addition, this aspect may generally present the same or corresponding advantages as the former aspects.

According to another aspect, there is provided a method of manufacturing the electro-optical component for adaptive visual correction according to the above, comprising calculating a maximum value for a distance from any point in said liquid-crystal gap to a nearest spacer in said plurality of spacers based on material properties of said first transparent substrate and said second transparent substrate; and distributing said plurality of spacers in two dimensions throughout said liquid-crystal gap so that each such distance is below said maximum distance.

Such material properties may, for example, be material type, thickness, Young's modulus and/or maximum thermoforming temperature.

By calculating the maximum distance based on material properties, rather than, e.g., only the geometry, the spacer arrangement may be optimized for the specific combination of geometry and materials at hand. Hereby, better control of the liquid-crystal gap may be achieved, which may make it possible to use thinner and/or more flexible substrates than otherwise possible, allowing, for example, for a thinner and/or lighter contact lens.

In addition, this aspect may generally present the same or corresponding advantages as the former aspects.

### BRIEF DESCRIPTION OF THE DRAWINGS

The above, as well as additional objects, features and advantages of the present inventive concept, will be better understood through the following illustrative and non-limiting detailed description, with reference to the appended drawings. In the drawings like reference numerals will be used for like elements unless stated otherwise.

FIG. 1A shows an electro-optical component.

FIG. 1B shows an electro-optical component having a curved shape.

FIGS. 2A, 2B, and 2C show a first spacer configuration.

FIGS. 3A and 3B show a second spacer configuration.

FIG. 4 shows an optical structure comprising a central indent.

FIGS. 5a and 5b show molds for manufacturing spacers of the electro-optical component.

FIG. 6 illustrates molding the spacers from a positive master mold.

FIG. 7 illustrates laser ablation.

### DETAILED DESCRIPTION

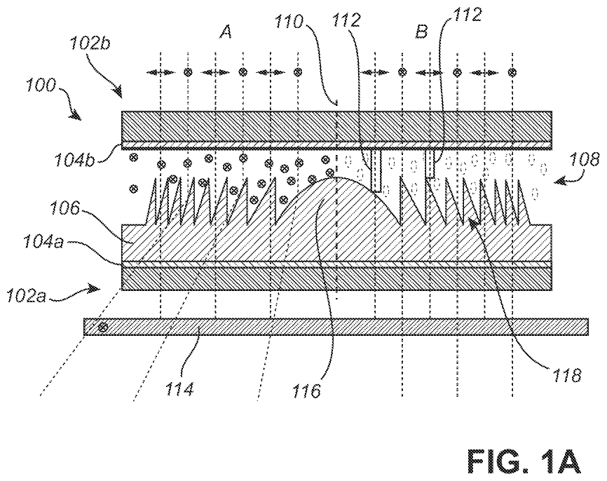

FIG. 1A shows an electro-optical component 100 for adaptive visual correction.

The electro-optical component 100 may, for example, be integrated into a contact lens, which, for example, may be a so-called smart contact lens. The contact lens may deal with the treatment of presbyopia, which is the age-related reduced accommodation capability of the eyes. To re-enable a person to accommodate vision (i.e. change the focus of the eye depending on the distance to the scene that is observed), the electro-optical component 100 may be integrated into the contact lens which allows, for example, for switching between two or more focal powers. For example, the contact lens may be able to switch between two focal powers, e.g., plano and minus 2 diopter (−2D).

For example, the electro-optical component may have a thickness of approximately 120 μm and a diameter of 7 mm.

The electro-optical component 100 may, as shown, be rotationally symmetric around an axis 110, with FIG. 1A showing a cross section therethrough.

In a sandwiched layer configuration, the electro-optical component 100 comprises, in order, a first transparent substrate 102a, a first transparent electrode 104a, an optical structure 106, a liquid-crystal gap 108, which may be filled with liquid crystals, a second transparent electrode 104b, and a second transparent substrate 102b.

The first transparent substrate 102a and the second transparent substrate 102b may be made of relatively thin and/or flexible materials. For example, the first transparent substrate 102a and the second transparent substrate 102b may be made of plastic films, e.g., PET, PMMA, or TAC.

For simplicity and clarity, the electro-optical component 100 of FIG. 1A, is shown in a straight configuration, i.e., the sandwiched layers lying in parallel planes. However, curved configurations are equally possible, as will be exemplified below in conjunction with FIG. 1B. All configurations and embodiments throughout this disclosure should be understood as applicable to such curved configurations.

The optical structure 106 may be considered a micro-optical structure.

As shown, the optical structure 106 may be a Fresnel lens structure and may comprise a central bulge 116 (as shown) or a central indent (as will be exemplified elsewhere below), and a plurality of concentric ridges 118 located radially outside the central bulge 116.

The first transparent electrode 104a and the second transparent electrode 104b are located on opposite sides of the liquid-crystal gap 108. As shown, the first transparent electrode 104a and the second transparent electrode 104b may, respectively, be integrated into and/or onto the first transparent substrate 102a and the second transparent substrate 102b. Other configurations (not shown) with the one or both of the first transparent electrode 104a and/or the second transparent electrode 104b being separate from the respective substrate 102a, 102b are equally possible. For example, the first transparent electrode 104a could be integrated into the optical structure 106, and/or be placed on the optical structure 106.

Further as shown, the optical structure 106 is disposed on the first transparent substrate 102a.

The liquid-crystal gap 108 is formed between the optical structure 106 and the second transparent substrate 102b and may, with the device in use, be filled with liquid crystals, as known per se.

The electro-optical component 100 may be coupled to a polarizer 114, not forming part of the electro-optical component 100.

Thus, the electro-optical component 100 is a liquid-crystal device comprising two transparent substrates 102a, 102b, of which one substrate 102a is covered with a micro-optical structure 106, with a thin liquid-crystal gap 108 in between. When the electro-optical component is use, the liquid-crystal gap 108 may be filled with liquid crystals, thus forming a thin liquid-crystal layer. Transparent electrodes 104a, 104b on both substrates are able to generate an electric field inside the liquid crystal present in the liquid-crystal gap 108.

The optical structure 106 is thus located adjacent to the liquid-crystal gap 108. When the liquid-crystal gap 108 is filled with liquid crystals, consequently, the optical structure 106 is contact with the liquid crystals of the liquid-crystal gap 108. Thus, the optical structure 106 is configured to be in contact with the liquid crystals of the liquid-crystal gap 108.

As known per se, the micro-optical structure 106 may be designed in such a way that in combination with the birefringent nature of the liquid crystals of the liquid-crystal gap 108, the electro-optical component 100 has a tunable lens functionality for one polarization state of light transmitted therethrough, as shown by dashed lines in FIG. 1A. By switching the liquid-crystal device cony (=voltage on, FIG. 1A, part B) or ‘off’ (=voltage off, FIG. 1A, part A), the cell is able to switch between two focal powers, e.g., plano and minus 2 diopter (−2D).

Optionally (not shown), in order to create a component that has tunable lens functionality for all light transmitted, regardless of the polarization state, two such electro-optic elements 100 can be stacked orthogonally on top of each other.

As is schematically shown in FIG. 1A, a plurality of spacers 112 is located in the liquid-crystal gap 108, and thus between the second transparent substrate 102b and the optical structure 106. The plurality of spacers 112 comprises at least one spacer having a different height than another spacer of the plurality of spacers 112, as will be elaborated upon in the following.

FIG. 1B shows an electro-optical component 200 having a curved shape. The curved shape is typically rotationally symmetric and may typically be a spherically curved shape. Apart from the curved shape, the electro-optical component 200 has the same features as described above for the electro-optical component 100 of FIG. 1A.

The manufacturing of such an electro-optical component 200 having a curved shape may comprise a transition from a flat state to a spherically curved state, for example, by thermoforming: a flat disc is, for example, inserted into a set of heated molds which are used to transform the flat disc into the desired spherically curved shape.

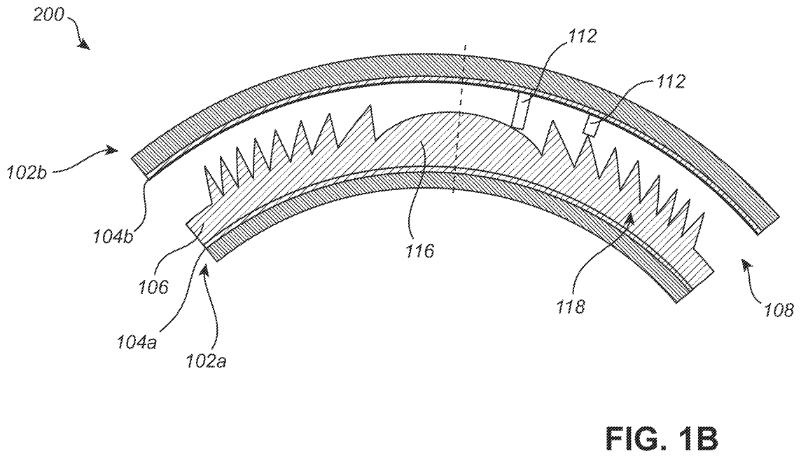

FIGS. 2A and 2B show a first spacer configuration in the liquid-crystal gap 108 between the optical structure 106 and the second transparent substrate 102b, which may form part of the electro-optical components 100, 200 disclosed above in conjunction with FIGS. 1A and 1B. As described above, the optical structure may comprise a central bulge 116 and a plurality of concentric ridges 118 located radially outside the central bulge, as typical for a Fresnel lens structure. FIG. 2A shows the radial disposition of the spacers while FIG. 2B shows the structure from above.

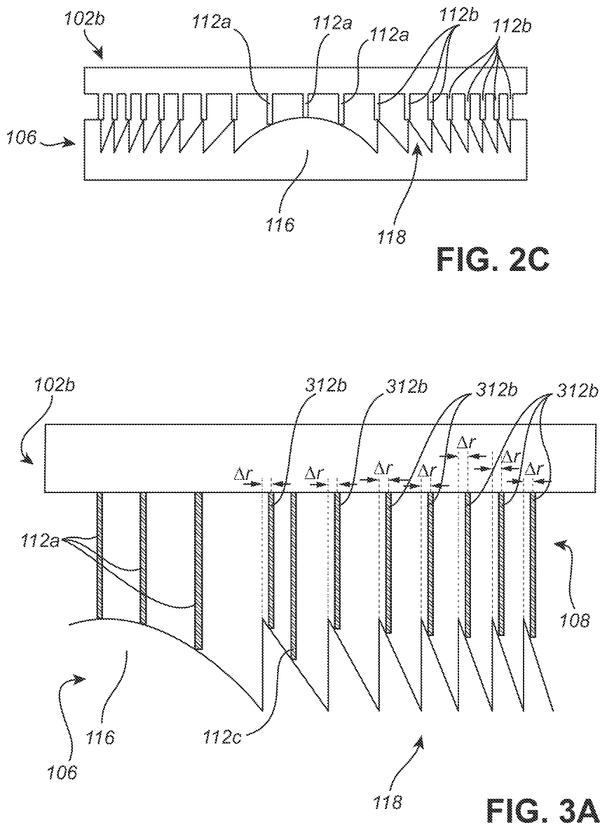

A plurality of spacers 112 is located in the liquid-crystal gap. In particular, the plurality of spacers comprises a plurality of different-height spacers 112a located at the central bulge 116 (or indent, cf. FIG. 4), and a plurality of constant-height spacers 112b, one spacer 112b of the plurality of constant-height spacers being located at each of the ridges of the plurality of concentric ridges 118.

For simplicity, all spacers are shown in a same radial cross-sectional view in FIG. 2A. However, as is evident from FIG. 2B, at each radial position, the spacers may be disposed at different circumferential position, for example to be evenly distributed circumferentially.

In the example of FIG. 2A, the plurality of different-height spacers at the central bulge comprises four spacers with respective lengths of 9, 9.25, 10, and 12 micrometers, following the contour of the central bulge 116. Naturally, other specific arrangements of different-height spacers 112a are possible within the teachings of the present disclosure.

Further, still with reference to the example of FIG. 2A, the plurality of constant-height spacers 112b at the plurality of ridges 118 may comprise spacers of length 10 micrometers. Naturally, other lengths are possible.

Typically, it may be beneficial for one or more of the radially innermost ridges to comprise further spacers apart from the plurality of constant-length spacers 112b. In the example of FIG. 2A, the radially innermost ridge has one further spacer 112c of length 12 micrometers.

FIG. 2C shows, schematically, a similar arrangement as in FIGS. 2A and 2B, comprising a plurality of spacers, which comprises a plurality of different-height spacers 112a located at the central bulge 116 (or indent, cf. FIG. 4); and a plurality of constant-height spacers 112b, one spacer 112b of the plurality of constant-height spacers being located at each of the ridges of the plurality of concentric ridges 118. In this example each spacer 112b of the plurality of constant-height spacer is located at an apex of the respective ridge.

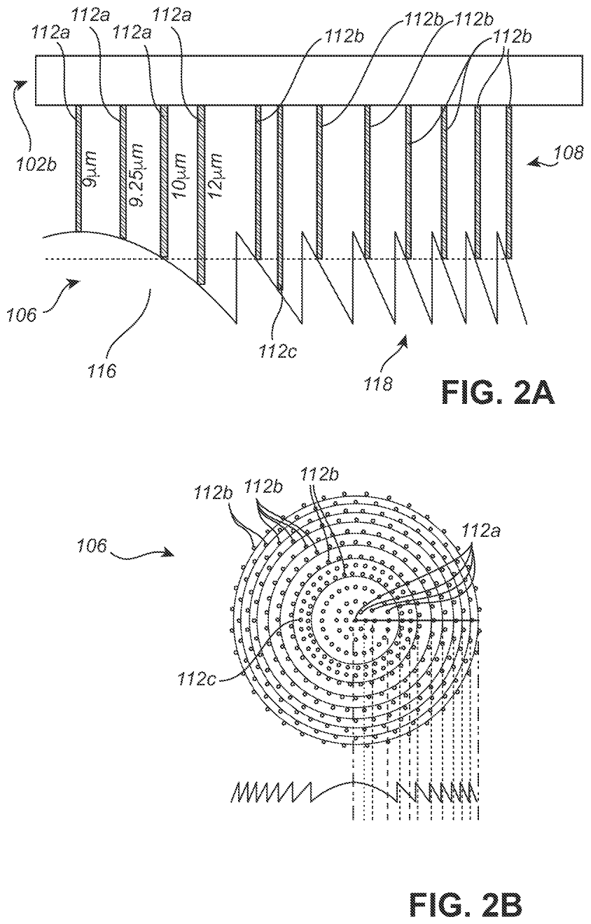

FIGS. 3A and 3B show a second spacer configuration, wherein, just as for FIGS. 2A and 2B discussed above, FIG. 3A shows the radial disposition of the spacers while FIG. 3B shows the structure from above.

Just as above, the second spacer configuration is formed in the liquid-crystal gap 108 between the optical structure 106 and the second transparent substrate 102b, which may form part of the electro-optical components 100, 200 disclosed above in conjunction with FIGS. 1A and 1B. As described above, the optical structure may comprise a central bulge 116 and a plurality of concentric ridges 118 located radially outside the central bulge, as typical for a Fresnel lens structure.

A plurality of spacers 112 is located in the liquid-crystal gap. The plurality of spacers comprises a plurality of different-height spacers 112a located at the central bulge 116—the concept is equally applicable to a central indent—and a second plurality of spacers 312b, one spacer 312b of the second plurality of spacers being located at each of the ridges of the plurality of concentric ridges 118. Furthermore, each of the spacers 312b of the second plurality of spacers is located at a same radial distance Or from the apex of the respective ridge.

For simplicity, all spacers are shown in a same radial cross-sectional view in FIG. 3A. However, as is evident from FIG. 3B, at each radial position, the spacers may be disposed at different circumferential position, for example to be evenly distributed circumferentially.

In the example of FIG. 3A, the plurality of different-height spacers at the central bulge comprises three spacers with different lengths, following the contour of the central bulge 116. Naturally, other specific arrangements of different-height spacers 112a are possible within the teachings of the present disclosure.

Typically, it may be beneficial for one or more of the radially innermost ridges to comprise further spacers apart from the second plurality of spacers 312b. In the example of FIG. 3A, the radially innermost ridge has one further spacer 112c.

FIG. 4 shows an optical structure 106 comprising a central indent 416 instead of a central bulge 116 (cf. FIGS. 1A-3B). Other features are as disclosed above in conjunction with FIGS. 2A-3B.

The spacers as disclosed above in conjunction with FIGS. 1A-4 may each have a rounded cross section, e.g., a circular cross section, each spacer thereby being cylindrical.

In the following methods of manufacturing the electro-optical components disclosed above will be exemplified.

The spacers may be manufactured though a molding process, in one of more steps.

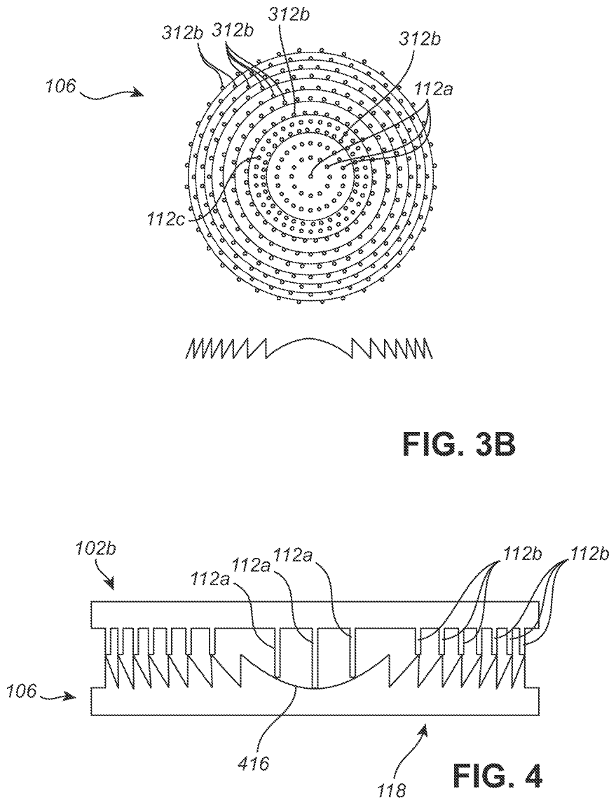

For example, the spacers may be molded from a negative master mold 502, as illustrated in FIG. 5a, with recesses 508 corresponding to the spacers to be molded.

Alternatively, the spacers may be molded from a positive master mold 504, as illustrated in FIG. 5b, with features 506 of the mold 504 directly corresponding in shape to the spacers to be molded.

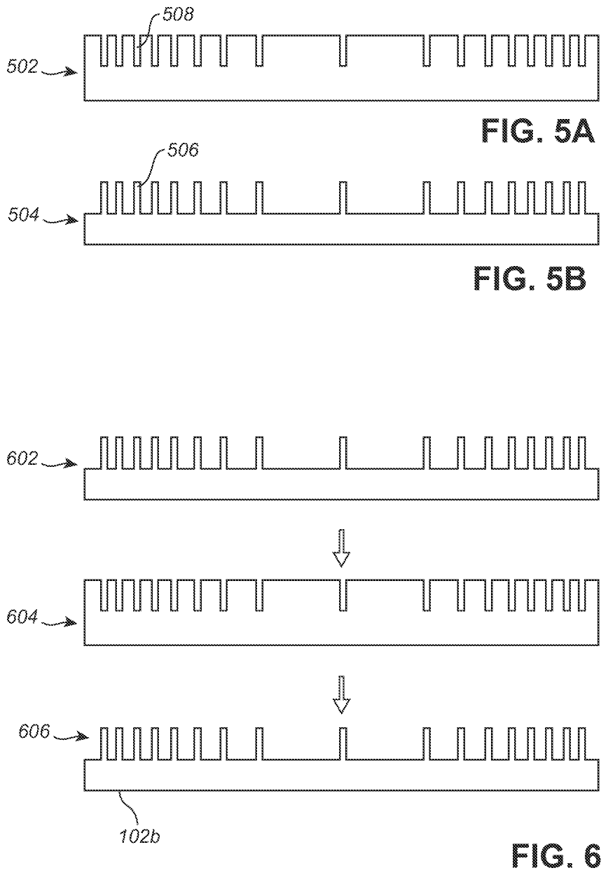

This is further illustrated in FIG. 6, showing an example of a molding procedure. First, a positive master mold 602 is created, for example using one or more of the methods described below. Then, a negative intermediate mold 604 is molded from the positive master mold 602. Finally, the final spacers 606 may be molded from the negative intermediate mold 604, whereby the spacers, for example, are embossed on the second transparent substrate 102b.

The master mold 602 can, for example, be a silicon wafer containing SU-8 features. By replica molding using polydimethylsiloxane (PDMS), the intermediate negative mold 604 can be created. This replica can in turn be used to emboss other (transparent) materials on the substrates used in the electro-optical component.

In other words, the master mold can be inverted or ‘negative’ in which case the spacers will be inverted (i.e. recesses), cf. FIG. 5a. The master mold can also be ‘positive’, cf. FIGS. 5b, 6, in which case the embossing will be a two-step procedure, whereby an intermediate negative mold will first be cast from the original positive master mold and subsequently used to emboss the actual substrate used in the electro-optical component. Thereby, at least part of the second transparent substrate is molded based on the master mold.

One method to manufacture placed spacers of different height is to use a sequence of multiple photolithographic steps using photo-imageable spin-on layers (e.g. SU-8), whereby different layer thicknesses are used for the consecutive steps. In every step, the spacers with a certain desired height corresponding to the thickness of the spin coated layer are produced.

Thus, the manufacturing method comprises applying a plurality of successive photolithographic layers to a substrate, wherein said at least one spacer is produced from at least one of said plurality of layers.

This method can be directly applied to the second transparent substrate 102b on which the spacers are to be created. Alternatively, the method may be applied to a different substrate, the different substrate thereby becoming a master mold, in particular a positive master mold, as described above.

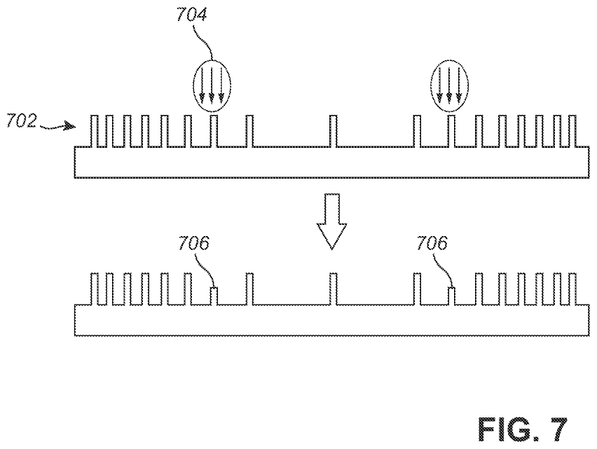

Another method to manufacture placed spacers of different heights is illustrated in FIG. 7, involving first producing plurality of spacers 702, which may, for example, be of equal, maximum height that is needed and subsequently making one or more of them 706 shorter using a technique to remove 704 material from the top of certain spacers. An example of such a technique is laser ablation. This allows for a large, almost continuous range of spacer heights, increasing flexibility.

Also this method can be directly applied to the substrate on which the spacers are to be created, for example an extra layer can be spin coated on the second transparent substrate 102b. Alternatively, the method may be applied to create a positive master mold, as described above. It can also be used to create a negative master mold by creating recesses of different depth in a uniform layer that is subsequently used to emboss the actual substrate that will be used in the electro-optical component.

Placing of the spacers in the liquid-crystal gap may be based on calculating a maximum value for a distance from any point in said liquid-crystal gap to a nearest spacer in said plurality of spacers based on material properties of said first transparent substrate and said second transparent substrate, using methods known per se, and then distributing said plurality of spacers in two dimensions throughout said liquid-crystal gap so that each such distance is below said maximum distance. Such material properties may, for example, be material type, thickness, Young's modulus and/or maximum thermoforming temperature.

In the above the inventive concept has mainly been described with reference to a limited number of examples. However, as is readily appreciated by a person skilled in the art, other examples than the ones disclosed above are equally possible within the scope of the inventive concept, as defined by the appended claims.

1. An electro-optical component for adaptive visual correction, comprising:
a first transparent substrate;
a second transparent substrate;
an optical structure disposed on the first transparent substrate;
a liquid-crystal gap located between the optical structure and the second transparent substrate;
a first transparent electrode and a second transparent electrode, located on opposite sides of the liquid-crystal gap; and
a plurality of spacers located in the liquid-crystal gap between the second transparent substrate and the optical structure,
wherein the plurality of spacers comprises at least one spacer having a different height than another spacer of the plurality of spacers.

2. The electro-optical component of claim 1, wherein the component has a curved shape.

3. The electro-optical component of claim 1, wherein the optical structure comprises a central bulge or indent and a plurality of ridges located radially outside the central bulge or indent, wherein the plurality of spacers comprises:
a plurality of different-height spacers located at the central bulge or indent; and
a plurality of constant-height spacers, one spacer of the plurality of constant-height spacers being located at each of the ridges.

4. The electro-optical component of claim 1, wherein the optical structure comprises a central bulge or indent and a plurality of ridges located radially outside the central bulge or indent, wherein the plurality of spacers comprises:
a plurality of different-height spacers located at the central bulge or indent; and
a second plurality of spacers, each spacer of the second plurality of spacers being located at a respective ridge of the plurality of ridges, wherein each of the spacers of the second plurality of spacers is located at a same radial distance from a respective apex of the respective ridge.

5. The electro-optical component of claim 1, wherein a spacer of plurality of spacers has a rounded cross section.

6. The electro-optical component of claim 1, wherein the optical structure is a Fresnel lens structure.

7. The electro-optical component of claim 1, wherein a contact lens comprises the component.

8. A method of manufacturing the electro-optical component for adaptive visual correction of claim 1,
wherein the method comprises applying a plurality of successive photolithographic layers to a substrate, and
wherein at least one spacer is produced from at least one of the plurality of layers.

9. The method of claim 8, wherein each layer is a photo-imageable spin-on layer.

10. The method of claim 8, wherein the substrate is the second transparent substrate.

11. The method of claim 8, wherein the substrate is a master mold and the method further comprises molding at least part of the second transparent substrate based on the master mold.

12. The method of claim 11, wherein the master mold is a positive master mold.

13. The method of claim 11, wherein the master mold is a negative master mold.

14. A method of manufacturing the electro-optical component for adaptive visual correction of claim 1, comprising:
producing a substrate comprising a plurality of spacers; and
creating the second transparent substrate by removing material from at least one spacer on the substrate.

15. A method of manufacturing the electro-optical component for adaptive visual correction of claim 1, comprising:
calculating a maximum value for a distance from any point in the liquid-crystal gap to a nearest spacer in the plurality of spacers based on material properties of the first transparent substrate and the second transparent substrate; and
distributing the plurality of spacers in two dimensions throughout the liquid-crystal gap so that each such distance is below the maximum distance.

16. The method of claim 9, wherein each layer is an SU-8 layer.

17. A method of manufacturing an electro-optical component for adaptive visual correction,
wherein the electro-optical component comprises:
a first transparent substrate;
a second transparent substrate;
an optical structure disposed on the first transparent substrate;
a liquid-crystal gap located between the optical structure and the second transparent substrate;
a first transparent electrode and a second transparent electrode, located on opposite sides of the liquid-crystal gap; and
a plurality of spacers located in the liquid-crystal gap between the second transparent substrate and the optical structure,
wherein the plurality of spacers comprises at least one spacer having a different height than another spacer of the plurality of spacers,
wherein the method comprises applying a plurality of successive photolithographic layers to a substrate, and
wherein at least one spacer is produced from at least one of the plurality of layers.

18. The method of claim 17, wherein each layer is a photo-imageable spin-on layer.

19. The method of claim 18, wherein the substrate is the second transparent substrate.

20. A method of manufacturing an electro-optical component for adaptive visual correction,
wherein the electro-optical component comprises:
a first transparent substrate;
a second transparent substrate;
an optical structure disposed on the first transparent substrate;
a liquid-crystal gap located between the optical structure and the second transparent substrate;
a first transparent electrode and a second transparent electrode, located on opposite sides of the liquid-crystal gap; and
a plurality of spacers located in the liquid-crystal gap between the second transparent substrate and the optical structure,
wherein the plurality of spacers comprises at least one spacer having a different height than another spacer of the plurality of spacers, and
wherein the method comprises:
producing a substrate comprising a plurality of spacers; and
creating the second transparent substrate by removing material from at least one spacer on the substrate.
